(19) United States
(12) Patent Application Publication
(10) Pub. No.: US 2011/0132270 A1
(43) Pub. Date: Jun. 9, 2011

(54) NOVEL DESIGN FOR A HANDLE CAPABLE OF BEING OPENED BY A HOUSEHOLD PET

(76) Inventor: Elizabeth Anne Wondowski, San Francisco, CA (US)

(21) Appl. No.: 12/630,799

(22) Filed: Dec. 3, 2009

(51) Int. Cl. A01K 29/00

(52) U.S. Cl. 119/174

(57) ABSTRACT

A handle capable of being used by a household pet to access food or litter is described. The handle includes: (i) a front portion capable of supporting thereon features to attract the household pet; (ii) a back portion that is disposed on or capable of being disposed on an opposite side of the front portion and the back portion protrudes outwardly away from the front portion such that a space is created between the front portion and the door when the back portion is connected to the door; and (iii) wherein the space allows the household pet to open the door and access the food or litter.

### BACKGROUND OF THE INVENTION

The present invention relates generally to a product for household pets, including but not limited to a dog or a cat. More particularly, the present invention relates to a door handle that is capable of being opened by household pets to access food and/or other substances, such as litter (hereinafter “food/litter”).

It is common practice to place food/litter in an open area inside a home so that household pets may have easy access to such food/litter without the need for human assistance.

Unfortunately this current practice suffers from several drawbacks. Most notably, many people find the odor from the food/litter displeasing. Furthermore, household pets often leave a mess around the location of food/litter. Further still, in small living quarters, food/litter occupies otherwise useful space.

Moreover, many household pets, particularly cats and some dogs, are typically thought to be shy animals that value their privacy. It is believed that such household pets would rather use litter and consume food in privacy, as opposed to the current practice of offering such necessities in open space.

What is therefore needed is a novel design or method for providing household pets access to food/litter in a space that is private and that does not suffer the drawbacks encountered by the current practice.

### SUMMARY OF THE INVENTION

In view of the foregoing, this invention provides novel handle designs which can be opened by a trained household pet. The handle designs are placed on a door attached to a closed compartment, such as a cabinet, which has food/litter placed therein. When a trained household pet opens the door using the novel handle, it has access to the food/litter. Although it is preferable to train a household pet to use the inventive door handles, it is not necessary. Untrained household pets can also use the door handles as described herein.

In one aspect, the present invention provides a handle capable of being used by a household pet to access food/litter. The handle includes: (i) a front portion capable of supporting thereon features to attract the household pet; (ii) a back portion that is disposed on or capable of being disposed on an opposite side of the front portion and the back portion protrudes outwardly away from the front portion such that a space is created between the front portion and the door when the back portion is connected to the door; and (iii) wherein the space allows the household pet to open the door and access the food/litter. The front portion may be made from a porous material that is capable of absorbing the scent of a household pet. Preferably, the front portion is made from wood and more preferably it is made from uncoated wood or plastic. The back portion may include any one of two rectangular blocks, a circular body, and a triangular body. Although not necessary, the protruding part may be connected to the back portion. In alternative embodiments of the present invention, the front portion and back portion are a unitary structure. The unitary structure at the back portion may be connected to the door which allows access to the food and/or litter. The handle is preferably attached to the door at a position or height that is reachable by a household pet.

In preferred embodiments of the present invention, the back portion of the handle may connect to a door using an adhesive, nail, or screw. When the handle is attached to a door, the space between the front portion and the door is preferably a value between about 1 inch and about 2 inches. The front portion may include a first edge and the back portion may include a second edge, the first and the second edges are disposed laterally with respect to each other and a distance separating the first edge from the second edge is a value that is between about 1 inch and about 2 inches.

In preferred embodiments, the present invention discloses a handle wherein the front portion is connected to the back portion, which is connected to the door that allows access to the food/litter. Preferably, the front portion includes a front face which is capable of supporting features to attract the household pet.

In another aspect, the present invention provides a method of assembling a handle-door subassembly that is capable of being used by a household pet to access food/litter. The inventive method includes (i) obtaining a handle including a front portion and a back portion, the front portion capable of supporting thereon features to attract the household pet, and the back portion protruding outwardly away from the front portion; and (ii) connecting the back portion to a door which is capable of being opened by the household pet using the handle to access the food/litter. In alternate embodiments, obtaining includes connecting the front portion to the back portion.

In another aspect, the present invention provides a method of providing a household pet access to food/litter in a closed compartment. The inventive method includes: (i) placing food/litter behind a door attached to the closed compartment; (ii) obtaining a handle including a front portion and a back portion, the front portion capable of supporting thereon features to attract the household pet, and the back portion protruding outwardly away from the front portion; and (iii) connecting the back portion of the handle to the door and creating a space between the front portion and the door, which is capable of being opened by the household pet using the handle to access the food/litter. In preferred embodiments, the space is large enough to allow a portion of the household pet to effectively engage with the back portion of the handle to open the door. Preferably, connecting includes connecting the back portion to the door at a height which will allow a household pet to engage with the handle.

In preferred embodiments, the inventive method further includes the step of disposing on the front portion features to attract the household pet. These features draw a household pet's attention to the door which will lead to food/litter. Furthermore, these features also allow a household pet to distinguish this particular door from the other neighboring doors, which are not the right ones to access food/litter.

The construction and method of operation of the invention, however, together with additional objects and advantages thereof will be best understood from the following descriptions of specific embodiments when read in connection with the accompanying figures.

### BRIEF DESCRIPTION OF THE DRAWINGS

FIG. 1A shows a front view of a handle, according to one preferred embodiment of the present invention, that is seen by a household pet.

FIG. 1B shows a side view of the handle shown in FIG. 1A.

FIG. 1C shows a back view, according to one embodiment of the present invention, of the handle shown in FIG. 1.

FIG. 1D shows a door having attached thereto a handle, according to a preferred embodiment of the present invention, at a height that is reachable by a household pet.

### DETAILED DESCRIPTION OF THE PREFERRED EMBODIMENTS

In the following description numerous specific details are set forth in order to provide a thorough understanding of the present invention. It will be apparent, however, to one skilled in the art that the present invention may be practiced without limitation to some or all of these specific details. In other instances, well known process steps have not been described in detail in order to not unnecessarily obscure the invention.

The present invention recognizes that household pets may be trained to use the inventive handles to open a door which provides access to cat food/litter.

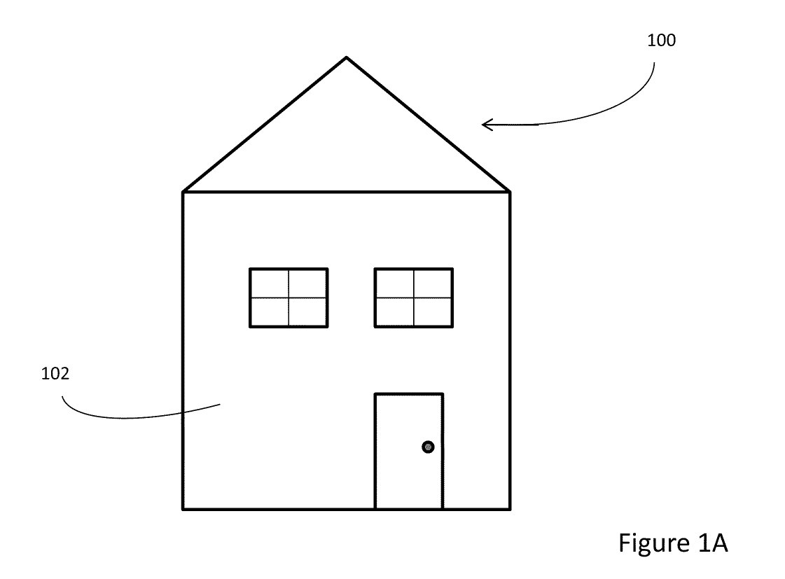

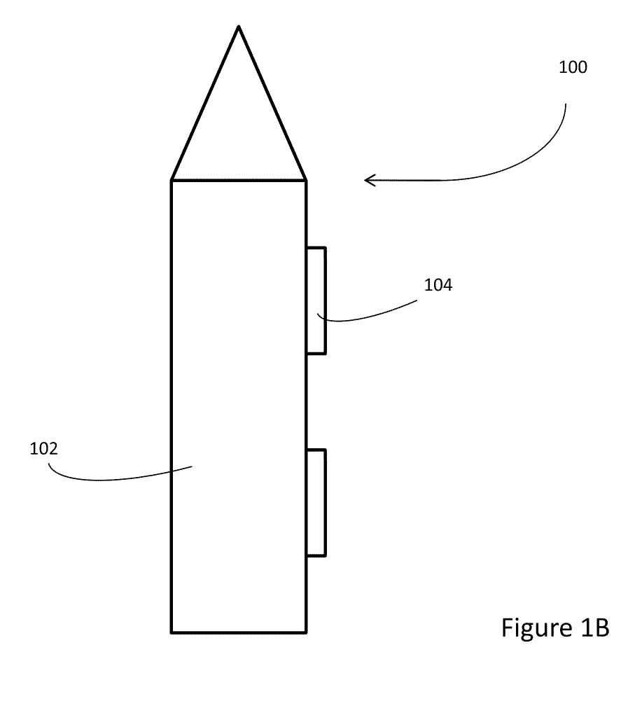

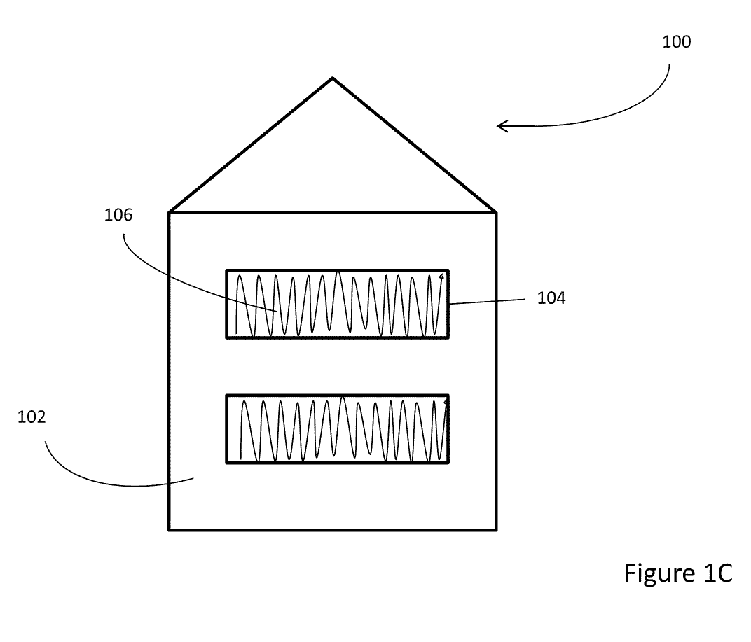

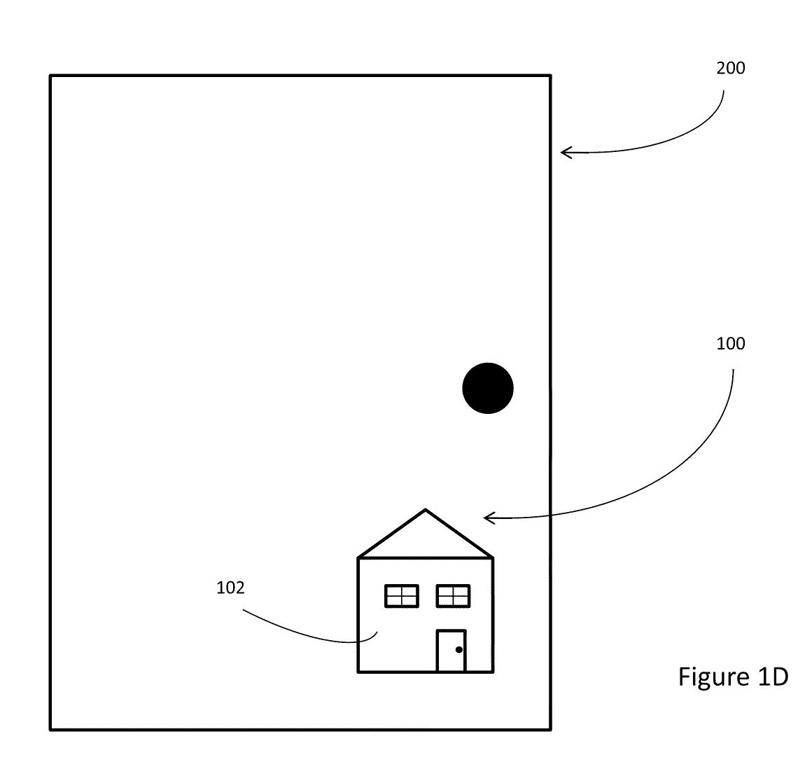

FIG. 1A shows a front view of a handle 100, according to one preferred embodiment of the present invention. Handle 100 is designed to attach to a door, which may provide a household pet a path of ingress or egress from a closed compartment, such as a cabinet. Food/litter is placed inside the closed compartment. Once a trained household pet enters the closed compartment it can use the litter or consume food in complete privacy, without any human intervention or assistance. Furthermore, the unsightly mess left behind by the household pet after availing itself of food/litter is also concealed by the closed compartment. Further still, the displeasing odor emanating from the food/litter is also contained inside the closed compartment. By providing food/litter in a closed compartment, the present invention provides open space (which is currently occupied to provide food/litter) for other uses.

FIG. 1A shows a front portion 102, which is preferably made from a porous material that is capable of retaining or absorbing a household pet's scent, including but not limited to the scent of a cat. Cats are known to mark certain objects, i.e., leave their scent behind on certain objects by rubbing their heads against that object. More preferably, front portion 102 is made from wood as cats are known to be attracted to wood. Most preferably, front portion 102 is made from uncoated wood, which is sufficiently porous and, therefore, ideal for absorbing a cat's scent after the object has been marked. In those instances where the household pet involves a dog, front portion 102 is preferably made from a plastic material, which may be bone-shaped, because a dog cannot chew through a plastic handle as easily as it can through a porous material and the bone shape would attract the dog.

In preferred embodiments of the present invention, front portion 102 is capable of supporting thereon features to attract a household pet. For example, FIG. 1A shows front portion 102 designed as house. While not wishing to be bound by any particular example, other examples might include front portion 102 designed with the features of a plant, a flower, a similar household pet, or anything that a household pet is known to fancy. Not only do such features attract the attention of a household pet, they also provide a means for the household pet to visually distinguish this handle from nearby door handles (described below with reference to FIG. 1D). As a result, front portion 102, among other things, serves to simplify a household pet's training process to recognize and use the handle to access food/litter.

FIG. 1B shows a side view of the handle, according to one embodiment of the present invention. FIG. 1B shows front portion 102 and back portion 104. Front portion 102 is pictured as a rectangle in FIG. 1B, though other shapes, such as a triangle or circle, could be used.

FIG. 1B also shows back portion 104 protruding outwardly from front portion 102. Although FIG. 1B shows back portion 104 with two protrusions, fewer or more protrusions could be used, so long as back portion 104 remains capable of being attached to a door in a secure enough manner that a household pet can use handle 100 to open the door.

In one embodiment of the present invention, back portion 104 is a unitary object carved from the same piece of material as front portion 102. In alternative embodiments of the present invention, however, as shown in FIG. 1B, back portion 104 may be attached to front portion 102 as a separate component or components (e.g., with nails, screws, or adhesive).

In preferred embodiments of the present invention, back portion 104 protrudes outwardly away from front portion 102 such that a space is created between front portion 102 and the door when back portion 104 is connected to the door. A household pet can use this space to pull a door open when handle 100 is attached. Preferably, the space is between about one inch and about two inches. Such dimensions of the space allow a household pet's paw to enter the space and thereby engage the handle to prop open the door.

FIG. 1C shows a back view of handle 100, according to one embodiment of the present invention. Handle 100 includes front portion 102, back portion 104, and an attachment mechanism 106. Although FIG. 1C shows attachment mechanism 106 as an adhesive, other attachment mechanisms may be used (e.g., nails or screws), so long as handle 100 is securely attached to a door allowing a household pet to use handle 100 to open a door which provides access to food/litter.

As shown in FIG. 1C, an edge of back portion 104 and an adjacent edge of front portion 102 are disposed laterally with respect to each other. The distance between each of these adjacent edges is enough to allow a household pet to effectively use handle 100 to open a door. Preferably, this space is between about one inch and about two inches.

FIG. 1D shows handle 100 attached to a door. Front portion 102 is designed in a way that distinguishes handle 100 from nearby door handles. A household pet is thus more easily trained and more easily recognizes handle 100 as providing access to food/litter. Furthermore, handle 100 attaches to a door at a position reachable by a household pet such that the household pet may use handle 100 to open a door to access food/litter. By way of example, handle 100 attaches to a door that is less than or equal to about 1 feet above the surface on which the household pet can stand to engage with the handle.

In one embodiment of the present invention, a unitary structure includes front portion 102 and back portion 104. In alternative embodiments of the present invention, the front portion 102 and back portion 104 are two discrete components which are assembled together to form inventive handles. By way of example, front portion 102 and back portion 104 connect to each other by any one of adhesive, nail and screw. Regardless of whether front portion 102 and back portion 104 form a unitary structure or are discrete components that connect to form a handle, the resulting handle is next attached to a door.

In accordance with one embodiment of the present invention, a method of assembling a handle-door subassembly 200 of FIG. 1D may begin when a handle including a front portion and back portion (e.g., front portion 102 and back portion 104 handle 100 in FIGS. 1B and 1C) is obtained. The back portion is then connected to a door that is capable of being used by a household pet using the inventive handle (e.g., handle 100 of FIG. 1D) to access food/litter. Specifically, in preferred embodiments of the present invention, adequate amount of space between the front portion and the door helps the cat in effectively using the handle. To this end, the back portion protrudes outwardly from the front portion (e.g., back portion 104 of handle 100 in FIG. 1B) and in a connected position of the handle to the door, the protrusion in the back portion creates the necessary space for the household pet to insert its paw or some other body part into the space to pry open the door.

In preferred embodiments of the present invention, the front portion is dressed up with features to attract a household pet (e.g., a house design shown on front portion 102 of handle 100 in FIGS. 1A and 1D). Other such visual features to attract a household pet include different colors, designs, or images.

In accordance with one embodiment of the present invention, a method provides a household pet access to food/litter in a closed compartment. Such inventive methods begin when food/litter is placed inside a closed compartment that has a door attached thereto. Next, a handle-door subassembly is formed to provide a requisite space which allows the household pet to engage the handle to pry open the door and access food/litter. Preferably, the handle is placed at a position or height on the door that will allow a household pet to use the handle.

Although illustrative embodiments of this invention have been shown and described, other modifications, changes, and substitutions are intended. Accordingly, it is appropriate that the appended claims be construed broadly and in a manner consistent with the scope of the disclosure, as set forth in the following claims.

1. A handle capable of being used by a household pet to access food or litter, said handle comprising:
a front portion capable of supporting thereon features to attract said household pet;
a back portion that is disposed on or capable of being disposed on an opposite side of said front portion and said back portion protrudes outwardly away from said front portion such that a space is created between said front portion and said door when said back portion is connected to said door; and
wherein said space allows said household pet to open said door and access said food or litter.

2. The handle of claim 1, wherein said back portion connects to a door using an adhesive.

3. The handle of claim 1, wherein said back portion connects to said door using a nail or a screw.

4. The handle of claim 1, wherein said front portion is composed of a porous material that is capable of absorbing scent of said household pet.

5. The handle of claim 1, wherein said front portion is made from uncoated wood or plastic.

6. The handle of claim 1, wherein said back portion includes any one of two rectangular blocks, a circular body and a triangular body.

7. The handle of claim 1, wherein said space is a value between about 1 inch and about 2 inches.

8. The handle of claim 1, wherein said front portion includes a first edge and said back portion includes a second edge, said first and said second edges are disposed laterally with respect to each other and a distance separating said first edge from said second edge is a value that is between about 1 inch and about 2 inches.

9. The handle of claim 1, wherein said protruding part protrudes outwardly a distance that is equal to or greater than 1 inch.

10. The handle of claim 1, wherein said handle is attached to said door at a position reachable by said cat.

11. The handle of claim 1, wherein said handle is a unitary structure which includes said front portion and said back portion.

12. The handle of claim 11, wherein said unitary structure at said back portion is connected to said door which allows access to said cat food and said cat litter.

13. The handle of claim 1, wherein said front portion is connected to said back portion, which is connected to said door that allows access to said food and said litter.

14. The handle of claim 1, wherein said front portion includes a front face which is capable of supporting said features to attract said household pet.

15. A method of assembling a handle and door subassembly that is capable of being used by a household pet to access food or litter, said method comprising:
obtaining a handle including a front portion and a back portion, said front portion capable of supporting thereon features to attract said household pet, and said back portion protruding outwardly away from said front portion;
connecting said back portion to a door which is capable of being used by a household pet using said handle to access said food or said litter.

16. The method of claim 15, wherein said obtaining includes connecting said front portion to said back portion.

17. A method of providing a household pet access to food or litter in a closed compartment, said method comprising:
placing food or cat litter behind a door attached to said closed compartment;
obtaining a handle including a front portion and a back portion, said front portion capable of supporting thereon features to attract said household pet, and said back portion protruding outwardly away from said front portion;
connecting said back portion of said handle to said door and creating a space between said front portion and said door, which is capable of being opened by said household pet using said handle to access said food or said litter.

18. The method of claim 17, further comprising disposing on said front portion features to attract said household pet.

19. The method of claim 17, wherein said space is large enough to allow a portion of said household pet to effectively engage with said back portion of said handle to open said door.

20. The method of claim 17, wherein said connecting includes connecting said back portion to said door at a height which will allow a household pet to engage with said handle.
